(19) United States
(12) Patent Application Publication
(10) Pub. No.: US 2024/0084837 A1
(43) Pub. Date: Mar. 14, 2024

(54) U-BOLT AND CONSTRUCTION METHOD

(71) Applicant: NIPPON TELEGRAPH AND TELEPHONE CORPORATION, Tokyo (JP)

(72) Inventors: Toshiki NAKANISHI, Tokyo (JP); Daiki KOBAYASHI, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/273,007

(22) PCT Filed: Jan. 25, 2021
(86) PCT No.: PCT/JP2021/002397

§ 371 Date: Jul. 18, 2023

(51) Int. Cl. F16B 31/02

(52) U.S. Cl. CPC F16B 31/02

(57) ABSTRACT

A U-bolt (10) according to the present disclosure is a U-bolt (10) fastened to a fastened object (2), the U-bolt including: a body part (11) which include a pair of shaft parts (111) aligned in a first direction and extending in a second direction orthogonal to the first direction, and a bridge part (112) which connects one ends of each of the pair of shaft parts (111), includes a U-shaped apex formed by the U-bolt (10), and is configured to be linearly symmetric with respect to an imaginary straight line (OX) extending in the second direction; and a pair of screw parts (12) provided at the other ends of each of the pair of shaft parts (111), in which a length mark indicating an index related to a length of the body part (11) along a direction in which the body part (11) extends from the apex is attached to each of the pair of shaft parts (111).

### TECHNICAL FIELD

The present disclosure relates to a U-bolt and an installing method.

### BACKGROUND ART

In the related art, a U-bolt has been used to fix a fastening object such as a pipe to a fastened object such as a frame or a wall surface. The U-bolt is a U-shaped bolt in which two linear shaft parts are connected by a bridge part. By inserting the shaft parts of the U-bolt into each of two through-holes provided in the fastened object in a state of sandwiching the fastening object inside the U-bolt, and fastening from each end part of the two shaft parts by a nut, the fastening object can be sandwiched and fixed by the U-bolt and the fastened object.

When the fastening object is fixed to the fastened object by the U-bolt, it is necessary to fix the U-bolt perpendicularly to the fastened object. However, since the U-bolt can only be tightened with nut by one of the two shaft parts, it is difficult to evenly fix the U-bolt to the left and right.

FIG. 10 is a diagram showing a relationship between a torque for fastening the nut to the shaft part of the U-bolt and the strain of each of the two shaft parts. FIG. 10 is a graph showing a relationship between torque T and strain ε of shaft parts A and B (strain εA of a shaft part A and strain εB of a shaft part B), when one (the shaft part A) of the two shaft parts is first tightened with a torque wrench and then the other shaft (the shaft part B) is tightened with the torque wrench.

As shown in FIG. 10, the shaft part A which has been tightened first is tightened more with a smaller torque than the shaft part B. That is, the relationship between the strain and the torque does not match between the right and left shaft parts A and B. Therefore, even if the fastening force of the nut is controlled by the torque wrench, since the nut is alternately fastened to the two shaft parts, it is difficult to fix the U-bolt by equalizing the strain of the two shaft parts due to a difference in correlation between the strain and the torque in the shaft parts A and B.

As shown in FIG. 11, NPL 1 discloses a technique for stably fixing a U-bolt to make it difficult to cause a displacement in a vertical direction (an extending direction of the shaft part), by machining a tip of the shaft part of the bolt into a tapered shape.

### CITATION LIST

### Non Patent Literature

[NPL 1] Takeshi Yamada, 4 others, “Structural characteristics of steel plate-concrete composite floor slabs using checkered steel plates and U-bolts to prevent slipping”, Proceedings of the 3rd Symposium on Decks of Highway Bridge, p 79-84, 2003

### SUMMARY OF INVENTION

### Technical Problem

When the U-bolt is fixed to a fastened object, as shown in FIG. 12, a displacement in a lateral direction occurs, and the U-bolt may be fixed in a state of being inclined in the horizontal direction. The technique described in the above-mentioned NPL 1 is a technique for making it difficult to cause a displacement in a vertical direction, and it is difficult to suppress the displacement in the horizontal and to fix the U-bolt by equalizing the strains of the two shaft parts. In addition, when the U-bolt is used as an infrastructure facility, since periodic inspection and repair are required, if the U-bolt body is formed into a complicated structure, it takes time and labor for inspection and repair.

An object of the present disclosure made in view of the above-mentioned problems is to provide a U-bolt and an installing method capable of fixing the U-bolt by equalizing strain of each of a pair of shaft parts, while suppressing complication of a structure of the U-bolt.

### Solution to Problem

In order to solve the above problem, a U-bolt according to the present disclosure is a U-bolt fastened to a fastened object, the U-bolt including: a body part which includes a pair of shaft parts aligned in a first direction and extending in a second direction orthogonal to the first direction, and a bridge part which connects one ends of each of the pair of shaft parts, and is configured to be linearly symmetric with respect to an imaginary straight line including an apex of a U-shape formed by the U-bolt and extending in the second direction; and a pair of screw parts provided at the other ends of each of the pair of shaft parts, in which a length mark indicating an index related to a length of the body part along a direction in which the body part extends from the apex is attached to each of the pair of shaft parts.

In addition, in order to solve the above problem, an installing method according to the present disclosure is an installing method for fastening a U-bolt to a fastened object, the U-bolt including a body part which includes a pair of shaft parts aligned in a first direction and extending in a second direction orthogonal to the first direction, and a bridge part which connects one ends of each of the pair of shaft parts, includes a U-shaped apex formed by the U-bolt, and is configured to be linearly symmetric with respect to an imaginary straight line extending in the second direction; and a pair of screw parts provided at the other ends of each of the pair of shaft parts, a length mark indicating an index related to a length of the body part along a direction in which the body part extends from the apex being attached to each of the pair of shaft parts, the installing method including a step of fastening the screw part inserted into a through-hole of the fastened object with a nut so that a length of the body part from the apex to the fastened object on one shaft part side based on the length mark attached to the one shaft part is substantially equal to a length of the body part from the apex to the fastened object on the other shaft part side based on the length mark attached to the other shaft part.

### Advantageous Effects of Invention

According to the U-bolt and the installing method according to the present disclosure, the U-bolt can be fixed by equalizing strain of each of the pair of shaft parts, while suppressing complication of a structure of the U-bolt.

### BRIEF DESCRIPTION OF DRAWINGS

FIG. 1 shows an example of a U-bolt according to a first embodiment.

FIG. 2 is an enlarged view showing the shaft part shown in FIG. 1.

FIG. 3 is a flow chart showing an example of an operation for fastening the U-bolt according to the first embodiment.

FIG. 4 is a diagram showing an example of U-bolt according to a second embodiment.

FIG. 5 is a flow chart showing an example of an operation for fastening the U-bolt according to the second embodiment.

FIG. 6 is an enlarged view showing a part of U-bolt according to a third embodiment.

FIG. 7 is a cross-sectional view showing an example of a nut for tightening a screw part of the U-bolt according to the third embodiment;

FIG. 8A is a diagram showing one state in which the screw part shown in FIG. 6 is fastened to the nut.

FIG. 8B is a diagram showing another state in which the screw part shown in FIG. 6 is fastened to the nut.

FIG. 9 is a flow chart showing an example of an operation for fastening the U-bolt according to the third embodiment.

FIG. 10 is a diagram showing an example of a relationship between torque and strain of the shaft part.

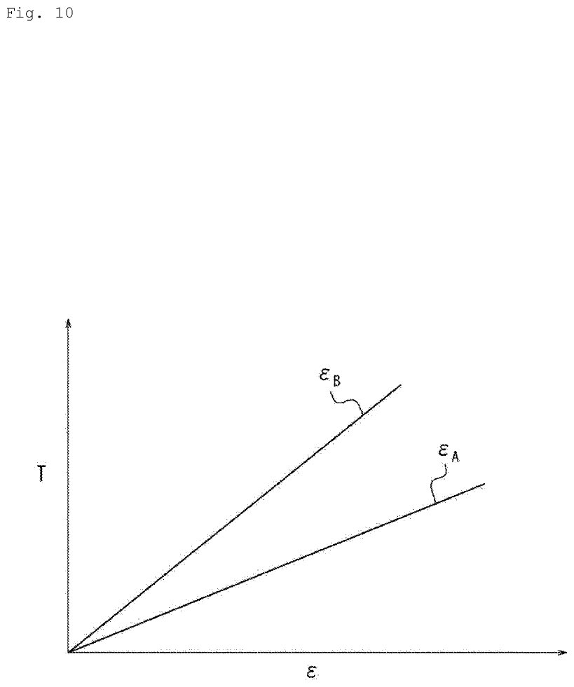

FIG. 11 is a diagram showing a vertical displacement of the shaft part of the U-bolt.

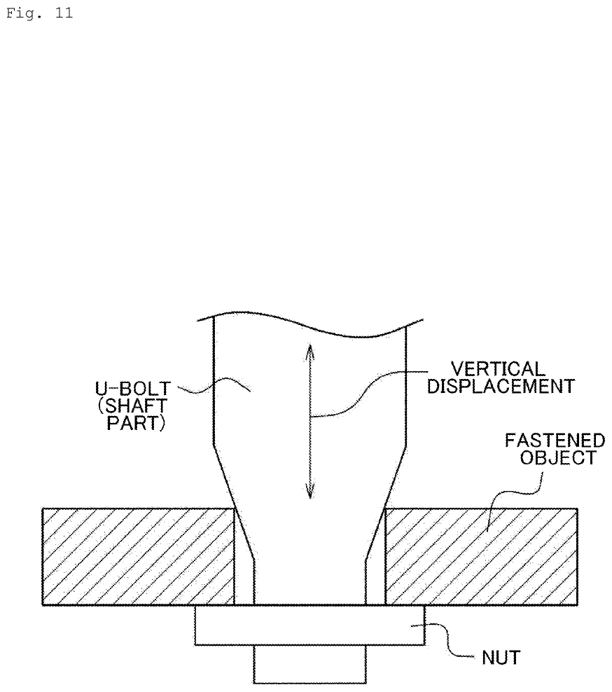

FIG. 12 is a view showing a horizontal displacement of the shaft part of the U-bolt.

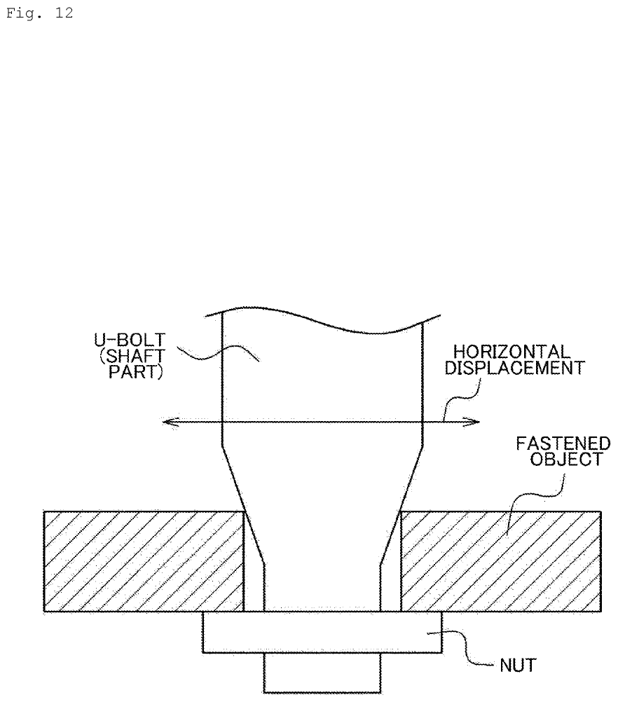

### DESCRIPTION OF EMBODIMENTS

A description will be attached below of embodiments of the present disclosure with reference to the drawings.

### First Embodiment

(Configuration of U-Bolt)

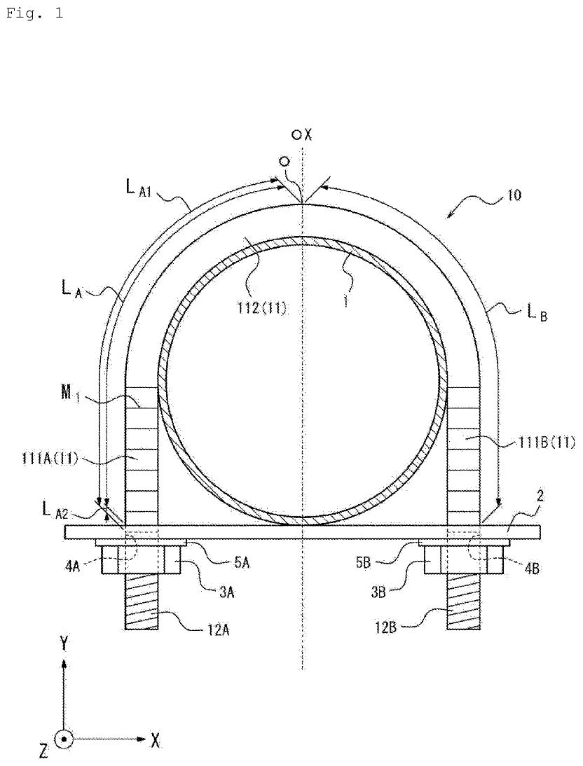

FIG. 1 is a diagram showing a configuration example of a U-bolt 10 according to a first embodiment of the present disclosure.

As shown in FIG. 1, the U-bolt 10 according to the present embodiment is made of a metal such as steel. The U-bolt 10 includes a body part 11 including a pair of shaft parts 111A and 111B and a bridge part 112, and a pair of screw parts 12A and 12B.

The shaft part 111A and the shaft part 111B are aligned in a predetermined direction and extend in a direction orthogonal to the predetermined direction. Hereinafter, as shown in FIG. 1, a direction in which the shaft part 111A and the shaft part 111B are aligned side by side is referred to as an X-axis direction (a first direction), a direction in which the shaft part 111A and the shaft part 111B extend is referred to as a Y-axis direction (a second direction), and a direction orthogonal to the X-axis direction and Y-axis direction is referred to as a Z-axis direction (a third direction). Hereinafter, when the shaft part 111A and the shaft part 111B are not distinguished from each other, they are referred to as a shaft part 111. Hereinafter, the shaft part 111A and the shaft part 111B are collectively referred to as a pair of shaft parts 111.

The bridge part 112 connects respective one ends of the shaft part 111A and the shaft part 111B. The bridge part 112 is configured line symmetrically with respect to an imaginary straight line OX (hereinafter referred to as an “imaginary line OX”) extending in the Y-axis direction including an U-shaped apex O formed by the U-bolt 10. The bridge part 112 is provided at one ends of each of the shaft part 111A and the shaft part 111B, and has a semi-circular curved shape. Since the bridge part 112 thus configured is provided at one end of the pair of shaft parts as described above, the U-bolt 10 forms a U-shape as a whole.

The screw part 12A and the screw part 12B have a screw thread structure, respectively. The screw part 12A and the screw part 12B are provided at the other ends of the shaft part 111A and the shaft part 111B, respectively. Hereinafter, when the screw part 12A and the screw part 12B are not distinguished from each other, they are referred to as a screw part 12. In the following description, the screw part 12A and the screw part 12B are collectively referred to as a pair of screw parts 12.

A fastening object 1 such as pipe is disposed inside the U-shaped U-bolt 10 (in a space surrounded by the pair of shaft parts 111 and the bridge part 112). In a state in which the fastening object 1 is disposed inside the U-bolt 10, a shaft part 111A and a shaft part 111B are inserted from one surface side of the fastened object 2 into a pair of through-holes 4A and 4B provided in the fastened object 2 such as support hardware, respectively. By inserting the shaft part 111A and the shaft part 111B into the through-hole 4A and the through-hole 4B, respectively, the screw part 12A and the screw part 12B of the shaft part 111A and the shaft part 111B protrude to the other surface side of the fastened object 2. The screw part 12A and the screw part 12B protruding from the other surface side of the fastened object 2 are fastened by a nut 3A and a nut 3B. The nut 3A and the nut 3B have a screw thread structure screwed with the screw thread structure of the screw part 12A and the screw part 12B, respectively. Thus, the fastening object 1 is sandwiched and fixed between the U-bolt 10 and the fastened object 2. Hereinafter, when the through-holes 4A and 4B are not distinguished, they are referred to as a through-hole 4. When the nut 3A and the nut 3B are not distinguished, they are referred to as a nut 3. A washer 5A and a washer 5B may be sandwiched between the nut 3A and the nut 3B and the fastened object 2. When the washer 5A and the washer 5B are not distinguished, they are referred to as a washer 5.

In this embodiment, a length mark M₁ indicating an index related to a length of the body part 11 along a direction in which the body part 11 extends from a U-shaped apex O formed by the U-bolt 10 is attached to each of the pair of shaft parts 111A and 111B. In the example of FIG. 1, a plurality of length marks M₁ are attached to each of the pair of shaft parts 111A and 111B. For example, the length mark M₁ can be a line segment extending in a direction orthogonal to the extending direction. The length marks M₁ may be provided at predetermined intervals in the extending direction. In the drawings referred to in each embodiment of the present specification, a mark “M₁” is attached only to one length mark M₁, and a mark “M₁” of the other length mark M₁ is omitted. The length mark M₁ may be attached to the shaft part 111A and the shaft part 111B to be line-symmetrical with respect to the imaginary line OX. That is, the length mark M₁ attached to one shaft part 111A of the pair of shaft parts 111 and the length mark M₁ attached to the other shaft part 111B of the pair of shaft parts 111 may be attached to the same position in the extending direction. Thus, the worker compares the length mark M₁ of the screw part 12A with the length mark M₁ attached to the same position in the extending direction as the screw part 12A in the screw part 12B, it is possible easily recognize whether the screw part 12A and the screw part 12B are almost uniformly fastened.

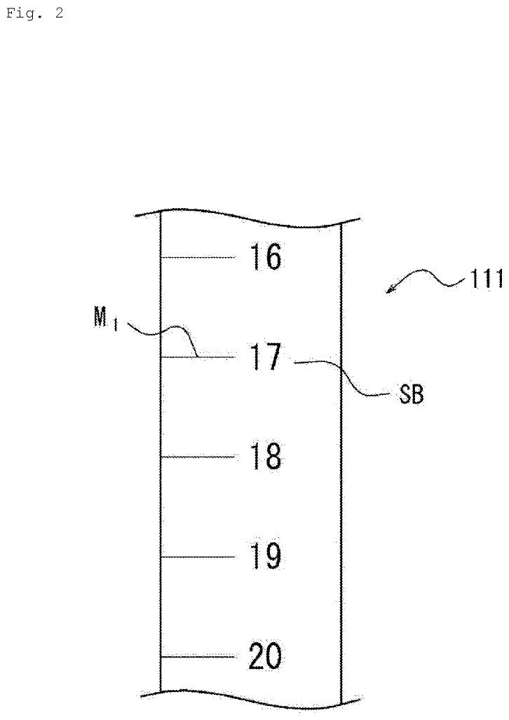

Further, as shown in FIG. 2, the shaft part 111A and the shaft part 111B may be further provided with a mark SB corresponding to the length mark M₁ attached to the shaft part 111A and the shaft part 111B, respectively. The mark SB may be a numeral, a symbol, a character, or the like. Thus, the worker can easily and appropriately recognize whether the screw part 12A and the screw part 12B are fastened uniformly to each other.

Further, the marks SB corresponding to the length marks M₁ which are attached to the shaft part 111A and the shaft part 111B and are positioned in linear symmetry may be the same as each other. The mark SB corresponding to the length mark M₁ may be a numeral indicating a distance from the apex O along the extending direction of the body part 11. Thus, the worker can easily identify the length mark M₁ attached to the same position in the extending direction as the screw part 12A in the screw part 12B, and thus can easily recognize whether the screw part 12A and the screw part 12B are almost uniformly fastened.

The length mark M₁ may be attached by an arbitrary method, and may be attached by, for example, coating with a coating material or the like, sticking if a tape or a seal, and formation of irregularities on the shaft part 111. When the length mark M₁ is attached by the formation of irregularities on the shaft part 111, the length mark M₁ can be suppressed from being erased due to wear due to aging. The formation of the irregularities on the shaft part 111 can be made by the formation of a marking line using a needle having hardness higher than that of the U-bolt 10, and the formation of a recess using a laser marking method. By forming the irregularities in this way, the length mark M₁ can be easily manufactured, and since the irregularities formed in this way are hard to be erased by wear, durability is improved.

(Installing Method of Fastening U-Bolt)

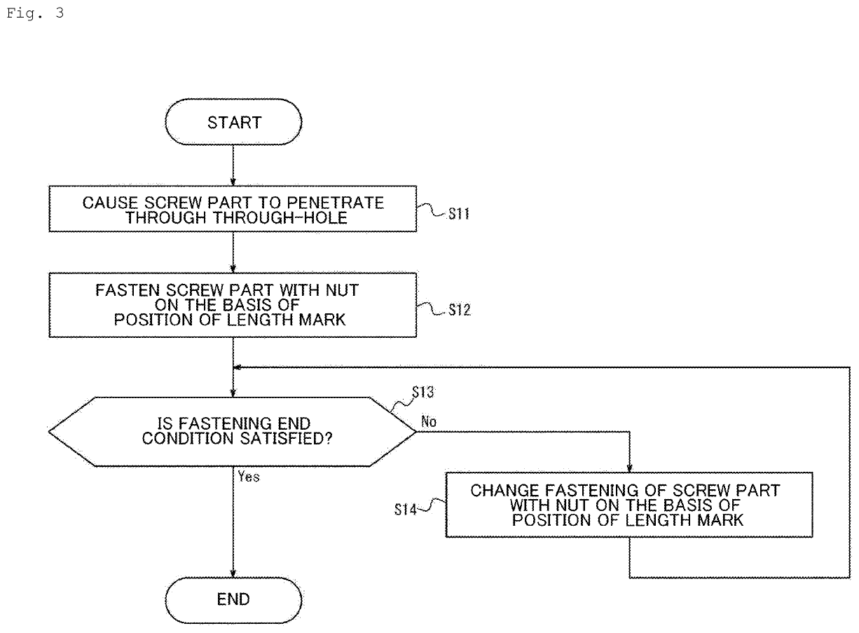

Here, the operation for fastening the U-bolt 10 according to the first embodiment will be described with reference to FIG. 3. FIG. 3 is a flow chart showing an example of the operation for fastening the U-bolt 10 according to the first embodiment. The operation for fastening the U-bolt 10 described with reference to FIG. 3 corresponds to the installing method for fastening the U-bolt 10 according to the first embodiment.

In a step S11, the worker causes the screw part 12 of the U-bolt 10 to penetrate through the through-hole 4.

In a step S12, the worker fastens the screw part 12 by a nut 3 on the basis of the position of the length mark M₁.

Specifically, the worker fastens the screw part 12 with the nut 3 on the basis of the position of the length mark M₁ with respect to the fastened object 2. For example, the worker fastens the screw part 12 with the nut 3 such that a length L_{A} of the body part 11 from the apex O to the fastened object 2 on the one shaft part 111A side based on the length mark M₁ attached to the one shaft part 111A is substantially equal to a length L_{B} of the body part 11 from the apex O to the fastened object 2 on the other shaft part 111B side based on the length mark M₁ attached to the other shaft part 111B. The term “substantially equal” indicates that a difference between a distance between the length mark M₁ attached to one screw part 12A and the fastened object 2 and a distance between the length mark M₁ attached to the other screw part 12A and the fastened object 2 is equal to or less than a predetermined value.

In step S13, the worker determines whether fastening end condition is satisfied. At this time, the worker can use any method in determining whether the fastening end condition is satisfied. For example, when the torque of the screw part 12 measured using a torque wrench reaches a specified value, the worker may determine whether the fastening end condition is satisfied, when the length L_{A} of the body part 11 from the apex O to the fastened object 2 on one shaft part 111A side is substantially equal to the length L_{B} of the body part 11 from the apex O to the fastened object 2 on the other shaft part 111B side. Further, when the screw part 12 is completely fastened with the nut 3, that is, when the nut 3 cannot be further rotated in a direction of fastening the screw part 12, when the length L_{A} of the body part 11 from the apex O to the fastened object 2 on the one shaft part 111A side is substantially equal to the length L_{B} of the body part 11 from the apex O to the fastened object 2 on the other shaft part 111B side, the worker may determine that the fastening end condition is satisfied. In this case, when the screw part 12 is not completely fastened with the nut 3, that is, when the nut 3 can be further rotated in the direction of fastening the screw part 12, the worker determines that the fastening end condition is not satisfied. Also, even when the length L_{A} of the body part 11 from the apex O to the fastened object 2 on one shaft part 111A side is not substantially equal to the length L_{B} of the body part 11 from the apex O to the fastened object 2 on the other shaft part 111B side, the worker determines that the fastening end condition is not satisfied.

When it is determined that the fastening end condition is satisfied in the step S13, the worker ends the operation for fastening the U-bolt 10. When it is determined that the fastening end condition is not satisfied in the step S13, the worker changes fastening of the screw part 12 to the nut 3 in the step S14. Here, the worker fastens the screw part 12 with the nut 3 on the basis of the position of the length mark M₁ attached to the screw part 12. Specifically, the worker fastens the screw part 12 with the nut 3 on the basis of the position of the length mark M₁ with respect to the fastened object 2. The worker may change the fastening of one of the shaft part 111A and the shaft part 111B, or may change the fastening of both of the shaft part 111A and the shaft part 111B.

When the fastening of the screw part 12 to the nut 3 is changed in the step S14, the processing is returned to the step S13 and the processing is repeated.

In the case where the worker inspects and adjusts the U-bolt 10 already fastened to the fastened object 2, the screw part 12 has already passed through the through-hole 4. In this case, the worker may not execute the processing of the step S11.

As described above, according to the first embodiment, the pair of shaft parts 111 are each provided with the length mark M₁ indicating an index related to the length of the body part 11 along the direction in which the body part 11 extends from the apex O. Thus, the worker can appropriately recognize the degree of fastening each of the screw part 12A and the screw part 12B to the nuts 3A and 3B, in the work of fastening the U-bolt 10 to the fastened object 2. Therefore, the U-bolt can be fixed by equalizing the strain of each of the pair of shaft parts, while suppressing complication of the structure of the U-bolt. Accordingly, the worker can firmly fix the fastening object 1.

According to the first embodiment, the length mark M₁ attached to one shaft part 111A of the pair of shaft parts 111 and the length mark M₁ attached to the other shaft part 111B of the pair of shaft parts 111 may be attached to the same position in the extending direction. Thus, the worker can properly recognize whether the screw part 12A and the screw part 12B are fastened uniformly to each other.

In the first embodiment, the length mark M₁ may be attached not only to the shaft part 111 but also to the bridge part 112.

### Second Embodiment

(Configuration of U-Bolt)

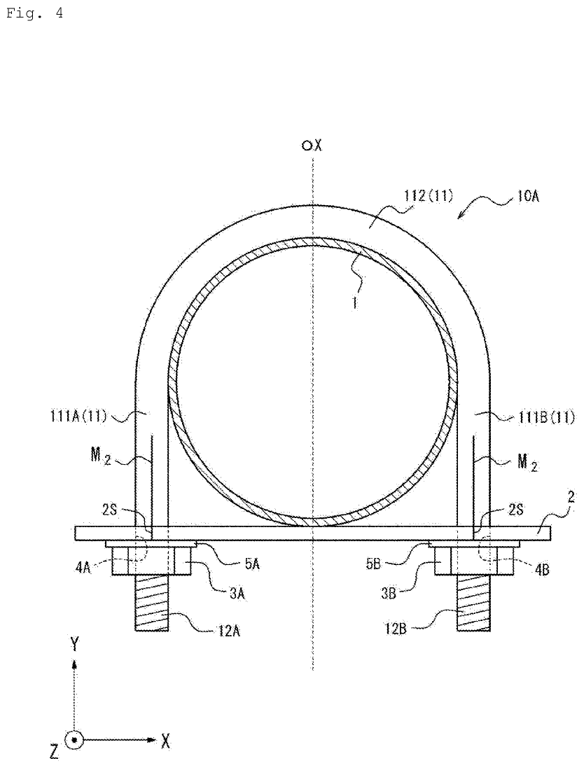

FIG. 4 is a view showing a configuration example of a U-bolt 10A according to a second embodiment of the present invention.

The U-bolt 10A according to the second embodiment includes a body part 11 including a pair of shaft parts 111A and 111B and a bridge part 112, and a pair of screw parts 12A and 12B, similarly to the U-bolt 10 according to the first embodiment.

The pair of screw parts 12A and 12B of the U-bolt 10A in the second embodiment, and the bridge part 112 are the same as the pair of screw parts 12A and 12B and the bridge part 112 of the U-bolt 10 in the first embodiment, respectively. A direction mark M₂ indicating an index related to the extending direction is attached to each of the pair of shaft parts 111A and 111B according to the second embodiment. For example, the direction mark M₂ can be a line segment extending in the extending direction.

A mark 2S for the fastened object showing a direction orthogonal to a surface of the fastened object 2 may be attached to the fastened object 2 to which the U-bolt 10A is fastened.

Further, the length mark M₁ attached to the pair of shaft parts 111A and 111B according to the first embodiment may be attached to the pair of shaft parts 111A and 111B according to the second embodiment. That is, both the length mark M₁ according to the first embodiment and the length mark M₂ according to the second embodiment may be attached to the pair of shaft parts 111A and 111B.

Thus, in the work for fastening the U-bolt 10A to the fastened object 2, the worker can appropriately recognize the degree of fastening each of the screw part 12A and the screw part 12B to the nuts 3A and 3B, and can fasten the screw part 12 with the nut 3 so that the direction orthogonal to the surface of the fastened object 2 indicated by the mark 2S for the fastened object, and the extending direction indicated by the direction mark M₂ are substantially the same. Therefore, the worker can uniformly fasten the pair of shaft parts 111A and 111B to the fastened object 2 so that both of them are almost perpendicular to the surface of the fastened object 2.

(Installing Method of Fastening U-Bolt)

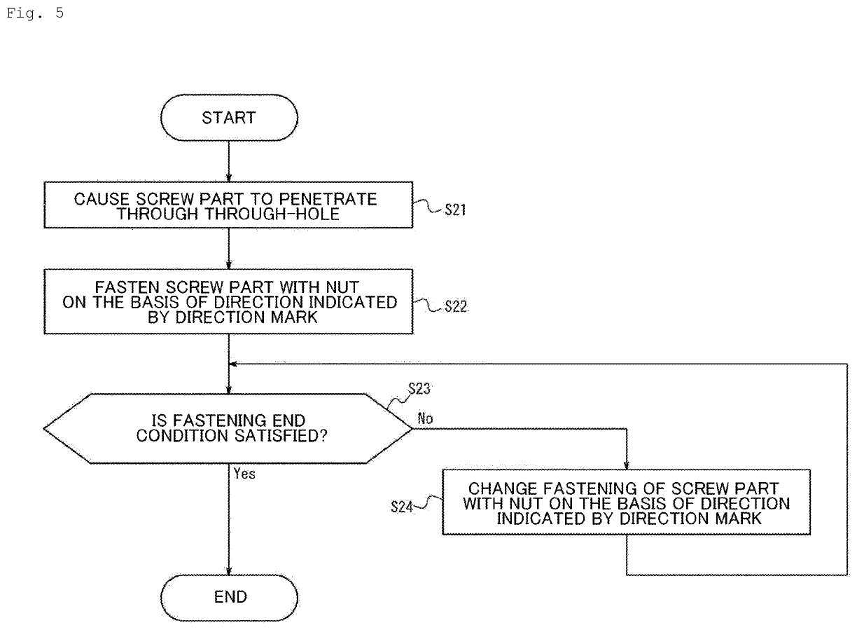

The operation for fastening the U-bolt 10A according to the second embodiment will now be described with reference to FIG. 5. FIG. 5 is a flowchart showing an example of the operation for fastening the U-bolt 10A according to the second embodiment. The operation for fastening the U-bolt 10A described with reference to FIG. 5 corresponds to the installing method for fastening the U-bolt 10A according to the second embodiment.

In step S21, the worker causes the screw part 12 of the U-bolt 10A to penetrate the through-hole 4.

In step S22, the worker fastens the screw part 12 with the nut 3 on the basis of a direction indicated by the direction mark M₂ attached to the shaft part 111. For example, the worker fastens the screw part 12 with the nut 3 on the basis of the directions indicated by each of the direction mark M₂ attached to the shaft part 111 and the mark 2S for the fastened object attached to the fastened object 2. Specifically, the worker fastens the screw part 12 with the nut 3 so that the direction indicated by the direction mark M₂ and the direction indicated by the mark 2S for the fastened object are the same. When the mark 2S for the fastened object is not attached to the fastened object 2, the worker fastens the screw part 12 with the nut 3 so that the direction indicated by the direction mark M₂ is orthogonal to the surface on the bridge part 112 side of the fastened object 2.

In step S23, the worker determines whether the fastening end condition is satisfied. At this time, the worker can use any method in determining whether the fastening end condition is satisfied. For example, when the torque of the screw part 12 measured using a torque wrench reaches a specified value, the worker may determine whether the fastening end condition is satisfied when the length L_{A} of the body part 11 from the apex O to the fastened object 2 on one shaft part 111A side is substantially equal to the length L_{B} of the body part 11 from the apex O to the fastened object 2 on the other shaft part 111B side. Further, when the screw part 12 is completely fastened with the nut 3, that is, when the nut 3 cannot be further rotated in a direction of fastening the screw part 12, the worker may determine that the fastening end condition is satisfied when the length L_{A} of the body part 11 from the apex O to the fastened object 2 on the one shaft part 111A side is substantially equal to the length L_{B} of the body part 11 from the apex O to the fastened object 2 on the other shaft part 111B side. In this case, when the screw part 12 is not completely fastened with the nut 3, that is, when the nut 3 can be further rotated in the direction of fastening the screw part 12, the worker determines that the fastening end condition is not satisfied. Also, even when the length L_{A} of the body part 11 from the apex O to the fastened object 2 on one shaft part 111A side is not substantially equal to the length L_{B} of the body part 11 from the apex O to the fastened object 2 on the other shaft part 111B side, as worker determines that the fastening end condition is not satisfied.

When it is determined that the fastening end condition is satisfied in the step S23, the worker ends the operation for fastening the U-bolt 10A. When it is determined that the fastening end condition is not satisfied in step S23, the worker changes fastening of the screw part 12 to the nut 3 in step S24. Here, the worker fastens the screw part 12 with the nut 3 on the basis of the direction indicated by the direction mark M₂ attached to the shaft part 111. The worker may change the fastening of one of the shaft part 111A and the shaft part 111B, or may change the fastening of both the shaft part 111A and the shaft part 111B.

When the fastening of the screw part 12 to the nut 3 is changed in the step S24, the processing is returned to the step S23 and the processing is repeated.

When the worker inspects and adjusts the U-bolt 10A already fastened to the fastened object 2, the screw part 12 already penetrate through the through-hole 4. Therefore, the worker may not execute the processing of the step S21. When the length mark described in the first embodiment is attached to the shaft part 111, the processing of the step S12 of the first embodiment may be executed before or after the processing of the step S22, and the processing of the step S14 of the first embodiment may be executed before or after the processing of the step S24.

As described above, according to the second embodiment, the mark 2S for the fastened object indicating the direction orthogonal to the surface of the fastened object 2 is attached to the fastened object 2, and the direction mark M₂ indicating an index related to the extending direction is attached to each of the pair of shaft parts 111. Thus, the worker can fasten the screw part 12 with the nut 3 so that the direction orthogonal to the surface of the fastened object 2 indicated by the mark 2S for the fastened object is substantially the same as the extending direction indicated by the direction mark M₂. Therefore, the worker can fix the U-bolt by equalizing the strain of each of the pair of shaft parts, while suppressing the complication of the structure of the U-bolt 10A. Accordingly, the worker can firmly fix the fastening object 1.

### Third Embodiment

(Configuration of U-Bolt)

A U-bolt 10B according to the third embodiment is similar to the U-bolt 10 according to the first embodiment shown in FIG. 1, and the U-bolt 10B includes a body part 11 including a pair of shaft parts 111A and 111B and a bridge part 112, and a pair of screw parts 12A and 12B. The pair of screw parts 12A and 12B of the U-bolt 10B in the third embodiment, and the bridge part 112 are similar to each of the pair of screw parts 12A and 12B and the bridge part 112 of the U-bolt 10 in the first embodiment.

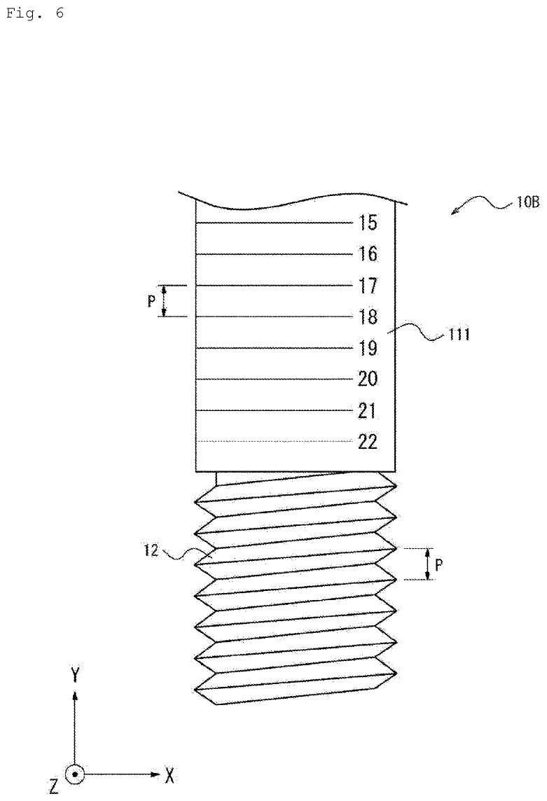

A plurality of length marks M₁ indicating positions in the extending direction are attached to the pair of shaft parts 111A and 111B according to the third embodiment, as in the first embodiment shown in FIG. 1. As shown in FIG. 6, the length marks M₁ in the third embodiment are provided at the same intervals as a pitch P of the screw threads in the extending direction of the screw part 12. The pitch p of the screw threads is an interval (a length in the extending direction) between the screw threads adjacent to each other in the extending direction. In such a configuration, when the screw part 12 is fastened to the nut 3 so that the nut 3 makes one round, the length of the body part 11 from the apex O to the fastened object 2 becomes shorter by the length of the pitch p.

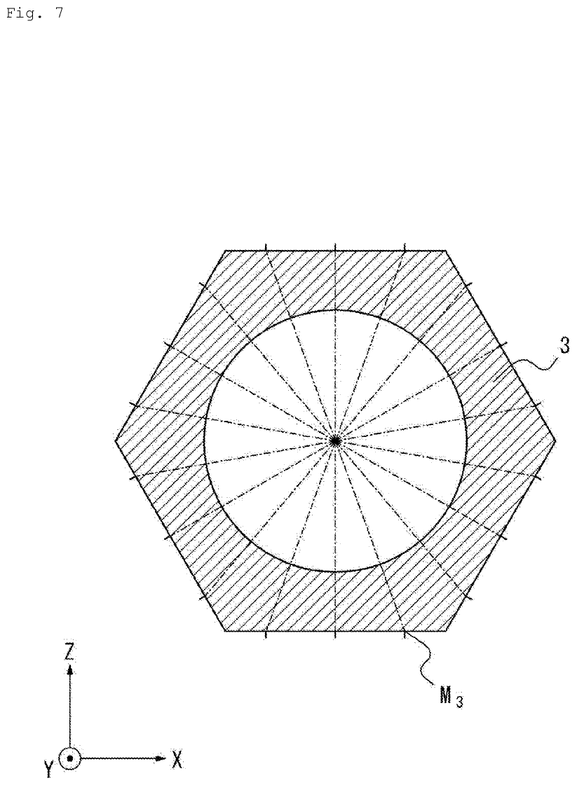

Further, as shown in FIG. 7, n (n is an integer of 2 or more) rotation marks M₃ of the nuts 3 are attached to the surfaces of the outer edge sides of each of the pair of nuts 3. In the example of FIG. 7, n=18 is satisfied. A position at which the rotation mark M₃ is attached is an intersection between a boundary line equally dividing an inner periphery of the nut 3 and a straight line which passes through a center point of the nut 3, on a surface of the outer edge side of the nut 3.

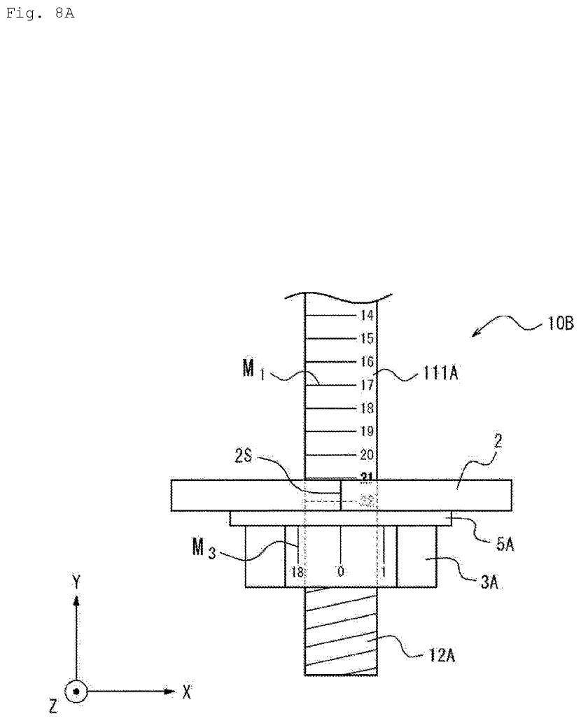

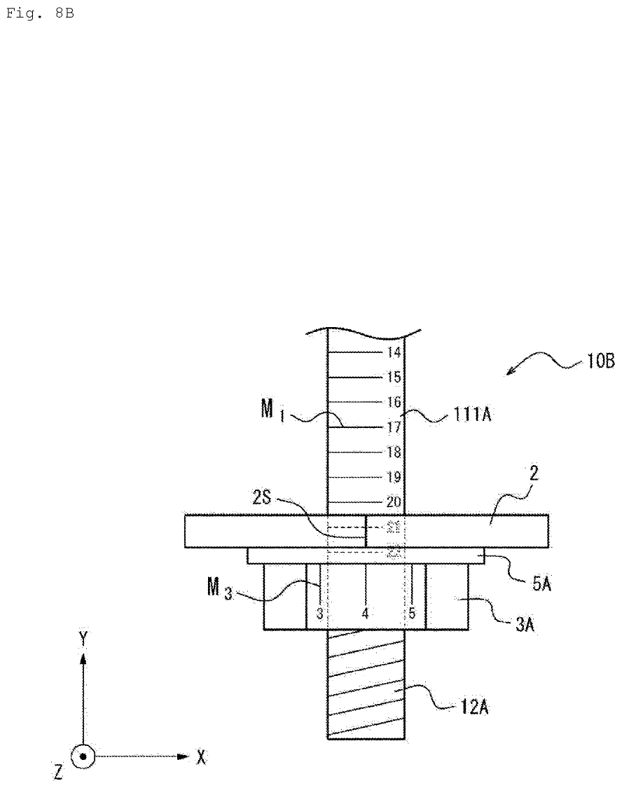

In such a constitution, when the nut 3 in the state shown in FIG. 8A rotates to the state shown in FIG. 8B to fasten the screw part 12, the rotation mark M₃ corresponding to a reference position of the fastened object 2 changes to the rotation mark M₃ adjacent by k pieces. The reference position is a position which is a reference in the fastened object 2.

The reference position may be an arbitrary position, but is preferably a position that is easy to be visually recognized by the worker. The reference position may be marked. In the examples shown in FIGS. 8A and 8B, the reference position is a position at which the above-mentioned mark 2S for the fastened object is attached. In this way, by changing the rotation marks M₃ to the adjacent rotation marks M₃ by k pieces, the length of the body part 11 from the apex O to the fastened object 2 is shortened by the length (p/n) sk.

In the drawing referred to in the third embodiment, a mark M₃ is attached only to one rotation mark M₃, and a mark M₃ of the other rotation mark M₃ is omitted. Although “22” shown by a mark SB attached to the shaft part 111A shown in FIG. 8A cannot be visually recognized because it is inserted into the through-hole 4A, it is shown for the sake of simplicity. The same also applies to “21” indicated by the mark SB shown in FIG. 8B and “22” indicated by the mark SB.

For example, the screw part 12 is fastened to the nut 3, as shown in FIG. 8A, the nut 3 is rotated from a state in which a rotation mark M₃ with “0” as the mark SB on the nut 3 exists at the reference position of the fastened object 2, and as shown in FIG. 8B, the nut 3 changes to a state in which a rotation mark M₃ with “4” as the mark SB on the nut 3 exists at a position corresponding to the reference position of the fastened object 2. By this change, the length from the apex O to the surface of the fastened object 2 is shortened by (p/18)×(4−0). Therefore, the worker can recognize the degree of fastening of the screw part 12 to the nut 3 with higher accuracy, by observing the positions of the plurality of rotation marks M₃ with respect to the reference positions in addition to the positions of the plurality of length marks M₁ with respect to the fastened object 2. The screw thread structure of the screw part 12 in FIGS. 8A and 8B is omitted, and a line segment indicating the position of the screw thread is attached.

The worker can calculate the length of the body part 11 from the apex O to the surface of the fastened object 2 on the basis of the position of the length mark M₁ attached to the shaft part 111 and the position of the rotation mark M₃ attached to the nut 3, using this principle. Specifically, the worker calculates the length L_{A} of the body part 11 from the apex O to the surface of the fastened object 2 on one shaft part 111A side, and the length L_{B} of the body part 11 from the apex O to the surface of the fastened object 2 on the other shaft part 111B side. The method of calculating the length L_{A} and the length L_{B} will be described in detail later.

(Installing Method of Fastening U-Bolt)

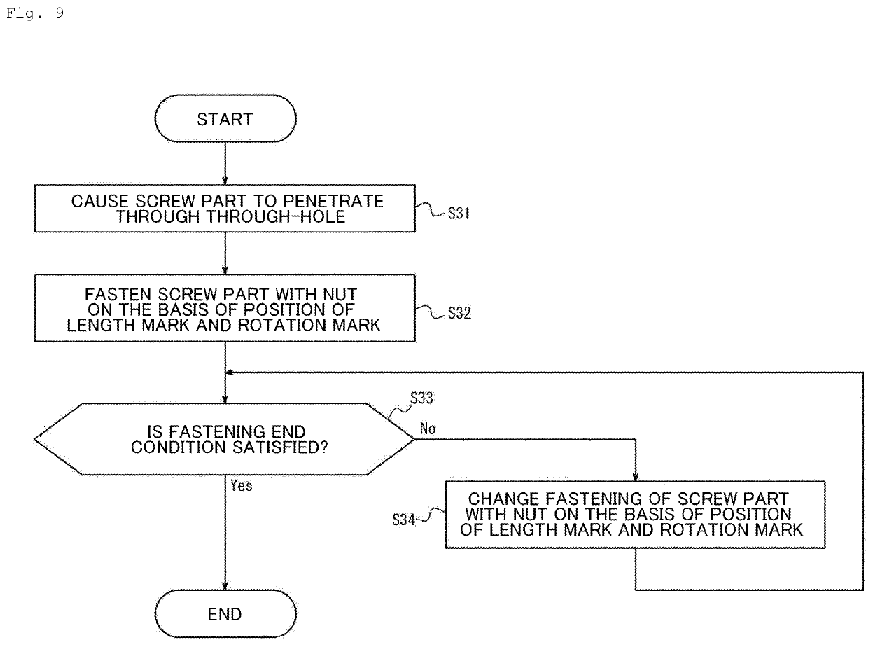

The operation for fastening the U-bolt 10B according to the third embodiment will now be described with reference to FIG. 9. FIG. 9 is a flow chart showing an example of the operation for fastening the U-bolt 10B according to the third embodiment. The operation for fastening the U-bolt 10B described with reference to FIG. 9 corresponds to the installing method for fastening the U-bolt 10B according to the third embodiment.

In step S31, the worker causes the screw part 12 of the U-bolt 10 to penetrate through the through-hole 4.

In step S32, the worker fastens the screw part 12 with the nut 3 on the basis of the positions of the length mark M₁ and the rotation mark M₃ attached to the shaft part 111. At this time, the worker calculates the length L_{A} on the basis of the length mark M₁ attached to one shaft part 111A and the rotation mark M₃ attached to a nut 3A for fastening a screw part 12A provided at the other end of the one shaft part 111A. The length L_{A} is the length of the body part 11 from the apex O to the fastened object 2 on one shaft part 111A side. Similarly, the worker calculates the length L_{B} on the basis of the length mark M₁ attached to the other shaft part 111B and the rotation mark M₃ attached to the nut 3A for fastening the screw part 12A provided at the other end of the other shaft part 111B. L_{B} is the length of the body part 11 from the apex O to the fastened object 2 on one shaft part 111A side.

A method of calculating the length L_{A} by the worker will now be described in detail. The worker recognizes the length mark M₁ (the length mark M₁ with “20” as the mark SB, in FIG. 8B) that is not inserted into the through-hole 4A and is closest to the surface of the fastened object 2 from the apex O, among the plurality of length marks M₁ attached to one shaft part 111A. Then, the worker calculates a length L_{A1} of the body part 11 up to a position indicating a length mark M₁ (the length mark M₁ with “21” as a mark SB in FIG. 8B) that is inserted into the through-hole 4A and closest to the surface of the fastened object 2. Then, the worker visually recognizes that the rotation mark M₃ at a position corresponding to the reference position of the fastened object 2 is a k-th rotation mark M₃ counted from the reference rotation mark M₃₀. The reference rotation mark M₃₀ is a rotation mark M₃ corresponding to the reference position of the fastened object 2, when the length mark M₁ closest to the surface of the fastened object 2 (the length mark M₁ with “21” as the mark SB in FIG. 8A) is positioned on the surface of the fastened object 2. Then, the worker calculates the length L_{A2} of the body part 11 from the position indicating the length mark M₁ closest to the surface of the fastened object 2 (the length mark M₁ with “21” as a mark SB in FIG. 8B) to the surface of the fastened object 2 as (p/n)×k. Subsequently, by subtracting the length L_{A2} from the length L_{A1}, the length L_{A} of the body part 11 from the apex O to the surface of the fastened object 2 on the shaft part 111A side is calculated.

The same also applies to a method of calculating the length L_{B} by the worker.

Then, the worker fastens the screw part 12 with the nut 3 so that the length L_{A} and the length L_{B} are substantially equal, that is, an absolute value of a difference between the length L A and the length L_{B} is equal to or less than a predetermined value.

In step S33, the worker determines whether the fastening end condition is satisfied with reference to FIG. 9 again. At this time, the worker can use any method in determining whether the fastening end condition is satisfied. For example, when the torque of the screw part 12 measured using a torque wrench reaches a specified value, the worker may determine whether the fastening end condition is satisfied, when the length L_{A} of the body part 11 from the apex O to the fastened object 2 on one shaft part 111A side is substantially equal to the length L_{B} of the body part 11 from the apex O to the fastened object 2 on the other shaft part 111B side. Further, when the screw part 12 is completely fastened with the nut 3, that is, when the nut 3 cannot be further rotated in a direction of fastening the screw part 12, the worker may determine that the fastening end condition is satisfied, when the length L_{A} of the body part 11 from the apex O to the fastened object 2 on the one shaft part 111A side is substantially equal to the length L_{B} of the body part 11 from the apex O to the fastened object 2 on the other shaft part 111B side. In this case, when the screw part 12 is not completely fastened with the nut 3, that is, when the nut 3 can be further rotated in the direction of fastening the screw part 12, the worker determines that the fastening end condition is not satisfied. Also, even when the length L_{A} of the body part 11 from the apex O to the fastened object 2 on one shaft part 111A side is not substantially equal to the length L_{B} of the body part 11 from the apex O to the fastened object 2 on the other shaft part 111B side, the worker determines that the fastening end condition is not satisfied.

When it is determined in the step S33 that the fastening end condition is satisfied, the worker ends the operation for fastening the U-bolt 10. When it is determined that the fastening end condition is not satisfied in the step S33, the worker changes fastening of the screw part 12 to the nut 3 in step S34. Here, the worker fastens the screw part 12 with the nut 3 on the basis of the position of the length mark M₁ attached to the screw part 12. Specifically, the worker fastens the screw part 12 with the nut 3 on the basis of the length mark M₁ attached to the screw part 12 and a distance between the fastened objects 2. The worker may change the fastening of one of the shaft part 111A and the shaft part 111B, or may change the fastening of both the shaft part 111A and the shaft part 111B.

When the fastening of the screw part 12 to the nut 3 is changed in the step S34, the processing is returned to the step S33 and the processing is repeated.

When the worker inspects and adjusts the U-bolt 10B already fastened to the fastened object 2, the screw part 12 already penetrates through the through-hole 4. Therefore, the worker may not execute the processing of the step S31.

As described above, according to the third embodiment, the length marks M₁ are provided at the same intervals as the pitch p of the screw thread in the second direction in the screw part 12, and a plurality of rotation marks M₃ are attached to intersections between a boundary equally dividing the inner periphery of the nut 3 and a straight line passing through the center point of the inner periphery, on the surface of the outer peripheral side each of the pair of nuts 3. Thus, the worker can calculate the length L of the body part 11 from the apex O to the surface of the fastened object 2 with higher accuracy, on the basis of the rotation mark M₃ corresponding to the reference position of the fastened object 2. Therefore, the worker can properly fasten the screw part 12 with the nut 3 so that the length L_{A} and the length L_{B} of the body part 11 from the apex O to the surface of the fastened object 2 become more uniform. Therefore, the worker can fix the U-bolt B by equalizing the strain of each of the pair of shaft parts, while suppressing complication of the structure of the U-bolt 10B. Accordingly, the worker can firmly fix the fastening object 1.

Although n=18 is set in the third embodiment, for example, by setting n=10, the process of calculating the length of the body part 11 from the apex O to the surface of the fastened object 2 is facilitated. In particular, in the present embodiment, the worker calculates the length of the body part 11 from the apex O to the surface of the fastened object 2, while performing the work of fastening the screw part 12 with the nut 3. Therefore, it is necessary for the worker to calculate the length by mental calculation, without operating an arithmetic unit, and since the processing of calculating the length is facilitated, convenience is remarkably improved.

### REFERENCE SIGNS LIST

1 Fastening object
2 Fastened object
2S Mark for fastened object
3, 3A, 3B Nut
4, 4A, 4B Through-hole
5, 5A, 5B Washer
10, 10A, 10B U-bolt
11 Body part
111, 111A, 111B Shaft part
112 Bridge part
12, 12A, 12B Screw part

1. A U-bolt fastened to a fastened object, the U-bolt comprising:
a body part, wherein the body part includes a pair of shaft parts and a bridge part, both shaft parts of the pair of shaft parts are aligned in a first direction and placed in a second direction orthogonal to the first direction, and the bridge part which connects one set of ends of each of the pair of shaft parts, and the bridge part is configured to be linearly symmetric with respect to an imaginary straight line extending in the second direction including a U-shaped apex formed by the U-bolt; and
a pair of screw parts provided at the other set of ends of each of the pair of shaft parts,
wherein a length mark indicating an index related to a length of the body part along a direction in which the body part extends from the apex is attached to each of the pair of shaft parts.

2. The U-bolt according to claim 1, wherein
the length mark is placed at a predetermined interval in the second direction.

3. The U-bolt according to claim 1, wherein
the length mark attached to one shaft part of the pair of shaft parts and the length mark attached to the other shaft part of the pair of shaft parts are attached at the same position in the second direction.

4. The U-bolt according to claim 1, wherein
the fastened object is marked with a mark for fastened object indicating a direction in which the fastened object is orthogonal, and
each of the pair of shaft parts is marked with a direction mark indicating an index related to the second direction.

5. The U-bolt according to claim 1, wherein
the pair of screw parts provided at the other set of ends of each of the pair of shaft parts are fastened by a pair of nuts,
the length mark is provided at the same interval as a pitch of a screw thread in the second direction in the screw part, and
a plurality of rotation marks are marked at an intersection between a boundary equally dividing an inner periphery of the pair of nuts and a straight line passing through a center point of the inner periphery, on a surface on an outer peripheral side of each of the pair of nuts.

6. An installing method for fastening a U-bolt to a fastened object,
the method comprising:
fastening the screw part inserted into a through-hole of the fastened object with a nut wherein
the U-bolt includes a body part, a bridge part, a pair of screw parts, and a length mark, the body part includes a pair of shaft parts, both shaft parts of the pair of shaft parts are aligned in a first direction and are placed in a second direction orthogonal to the first direction, the bridge part connects one set of ends of each of the pair of shaft parts, the bridge part is configured to be linearly symmetric with respect to an imaginary straight line extending in the second direction including a U-shaped apex formed by the U-bolt, the pair of screw parts is placed at the other set of ends of each of the pair of shaft parts, the length mark indicates an index associated with a length of the body part along a direction in which the body part extends from the apex being attached to each of the pair of shaft parts, and
a length of the body part from the apex to the fastened object on one shaft part side based on the length mark attached to the one shaft part is substantially equal to a length of the body part from the apex to the fastened object on the other shaft part side based on the length mark attached to the other shaft part.

7. The U-bolt according to claim 2, wherein
the length mark attached to one shaft part of the pair of shaft parts and the length mark attached to the other shaft part of the pair of shaft parts are attached at the same position in the second direction.

8. The U-bolt according to claim 2, wherein
the fastened object is marked with a mark for fastened object indicating a direction in which the fastened object is orthogonal, and
each of the pair of shaft parts is marked with a direction mark indicating an index related to the second direction.

9. The U-bolt according to claim 2, wherein
the pair of screw parts provided at the other set of ends of each of the pair of shaft parts are fastened by a pair of nuts,
the length mark is provided at the same interval as a pitch of a screw thread in the second direction in the screw part, and
a plurality of rotation marks are marked at an intersection between a boundary equally dividing an inner periphery of the pair of nuts and a straight line passing through a center point of the inner periphery, on a surface on an outer peripheral side of each of the pair of nuts.

10. The installing method according to claim 6, wherein
the length mark is placed at a predetermined interval in the second direction.

11. The installing method according to claim 6, wherein
the length mark attached to one shaft part of the pair of shaft parts and the length mark attached to the other shaft part of the pair of shaft parts are attached at the same position in the second direction.

12. The installing method according to claim 6, wherein
the fastened object is marked with a mark for fastened object indicating a direction in which the fastened object is orthogonal, and
each of the pair of shaft parts is marked with a direction mark indicating an index related to the second direction.

13. The installing method according to claim 6, wherein
the pair of screw parts provided at the other set of ends of each of the pair of shaft parts are fastened by a pair of nuts,
the length mark is provided at the same interval as a pitch of a screw thread in the second direction in the screw part, and
a plurality of rotation marks are marked at an intersection between a boundary equally dividing an inner periphery of the pair of nuts and a straight line passing through a center point of the inner periphery, on a surface on an outer peripheral side of each of the pair of nuts.

14. The installing method according to claim 10, wherein
the length mark attached to one shaft part of the pair of shaft parts and the length mark attached to the other shaft part of the pair of shaft parts are attached at the same position in the second direction.

15. The installing method according to claim 10, wherein
the fastened object is marked with a mark for fastened object indicating a direction in which the fastened object is orthogonal, and
each of the pair of shaft parts is marked with a direction mark indicating an index related to the second direction.

16. The installing method according to claim 10, wherein
the pair of screw parts provided at the other set of ends of each of the pair of shaft parts are fastened by a pair of nuts,
the length mark is provided at the same interval as a pitch of a screw thread in the second direction in the screw part, and
a plurality of rotation marks are marked at an intersection between a boundary equally dividing an inner periphery of the pair of nuts and a straight line passing through a center point of the inner periphery, on a surface on an outer peripheral side of each of the pair of nuts.
